(19) United States
(12) Patent Application Publication
(10) Pub. No.: US 2008/0240471 A1
(43) Pub. Date: Oct. 2, 2008

(54) ELECTRONIC DEVICE INCLUDING INTERNAL MICROPHONE ARRAY

(75) Inventors: Iou-Din Chen, San Jose, CA (US); Ying-Te Chu, Sanchong City (TW); Yu-Hsi Lan, Jhubei City (TW); Yi-Wen Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/693,774

(22) Filed: Mar. 30, 2007

(51) Int. Cl. H04R 3/00

(52) U.S. Cl. 381/150

(57) ABSTRACT

An electronic device includes a housing, a circuit board, and a microphone array. A plurality of acoustic openings is defined in the housing. The circuit board is placed in the housing. The microphone array is placed on the circuit board for receiving external sound via the acoustic openings in the housing.

### BACKGROUND OF THE INVENTION

1. Field of the Invention

The invention relates to an electronic device including an internal microphone array.

2. Description of the Related Art

A microphone array is capable of clearly receiving sound from a particular direction and avoiding environmental noise, thus, they are often applied in high-quality audio recorders and communications devices.

Most electronic devices have plastic or metal housings which are acoustic isolators. Acoustic isolators block sound waves, thus complicating microphone placement. Specifically, a microphone array presenting good performance in the open deteriorates when placed in the housing of an electronic device. The housing obstructs the microphone array, hindering reception of external sound.

### BRIEF SUMMARY OF THE INVENTION

Many devices, such as, portable computers, mobile phones, personal digital assistants and others are becoming increasingly compact and thin. In the invention, a microphone array is located in a “thin” electronic device to receive external sound via front and rear acoustic openings in the housing of the electronic device. The microphone array is near the front and rear acoustic openings, thus enhancing external sound reception capability.

In an exemplary embodiment of the invention, the electronic device includes a housing, a circuit board, and a microphone array. The housing defines a plurality of acoustic openings. The circuit board is disposed in the housing. The microphone array is also disposed on the circuit board for receiving external sound via the acoustic openings in the housings.

The electronic device may further comprise glue fixing the circuit board to the housing.

The electronic device may further comprise a screw fixing the circuit board to the housing.

The electronic device may further comprise an integrated circuit disposed on the circuit board.

The integrated circuit may comprise a digital signal processor.

The integrated circuit may comprise an analog-to-digital converter.

The integrated circuit and the microphone array may be disposed on the same side of the circuit board.

The integrated circuit and the microphone array may be disposed on opposite sides of the circuit board.

The microphone array may comprise a unidirectional microphone, and the circuit board may define a plurality of through holes around the unidirectional microphone.

At least one through hole may extend lengthwise beneath the unidirectional microphone.

The electronic device may further comprise a flexible holder holding the circuit board, wherein the housing comprises a front cover and a rear cover sandwiching the flexible holder therebetween.

The flexible holder may be substantially U-shaped.

The acoustic openings may comprise a first front acoustic opening, a second front acoustic opening, and a rear acoustic opening. The microphone array may comprise a unidirectional microphone receiving external sound via the first front acoustic opening and the rear acoustic opening, and an omnidirectional microphone receiving the external sound via the second front acoustic opening.

The flexible holder may comprise a first hole with the microphone array and a part of the circuit board inserted therein.

The flexible holder may further comprise a second hole connecting the first front acoustic opening of the housing and the first hole, a third hole connecting the rear acoustic opening of the housing and the first hole, and a fourth hole connecting the second front acoustic opening of the housing and the first hole.

The flexible holder may be hollow with the microphone array and the circuit board disposed therein.

The flexible holder may comprise a top opening connected to the first front acoustic opening of the housing, a top hole connected to the second front acoustic opening of the housing, and a bottom opening connected to the rear acoustic opening of the housing.

The electronic device may further comprise a conducting wire connected to the circuit board. The flexible holder may comprise a concave cut through which the conducting wire passes.

The flexible holder may comprise rubber.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a perspective diagram of a portable computer in accordance with a first embodiment of the invention;

FIG. 1B is a perspective diagram of the portable computer in accordance with the first embodiment of the invention, observed from different direction;

FIG. 1C is a sectional view of the portable computer in accordance with the first embodiment of the invention;

FIG. 1D is a top view of a circuit board of the portable computer in accordance with the first embodiment of the invention;

FIG. 1E depicts the circuit board of FIG. 1D with the microphone array thereon removed;

FIG. 2A is a sectional view of an electronic device in accordance with a second embodiment of the invention;

FIG. 2B is a perspective diagram of a circuit board held by flexible holders in accordance with the second embodiment of the invention;

FIG. 3 is a sectional view of an electronic device in accordance with a third embodiment of the invention;

FIG. 4A is a sectional view of an electronic device in accordance with a fourth embodiment of the invention;

FIG. 4B is an exploded perspective diagram of a circuit board and two flexible holders of the electronic device in accordance with the fourth embodiment of the invention;

FIG. 5A is a sectional view of an electronic device in accordance with a fifth embodiment of the invention;

FIG. 5B is an exploded perspective diagram of a circuit board and a flexible holder of the electronic device in accordance with the fifth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

While a portable computer described for the purposes of illustrating the invention, it is understood that the invention is equally applicable to a variety of “thin” electronic devices including mobile phones, personal digital assistants (PDAs), and others.

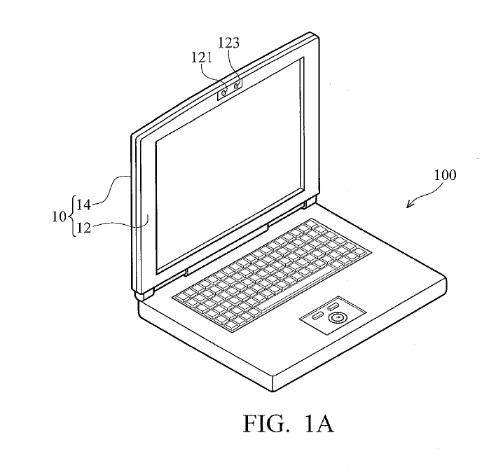

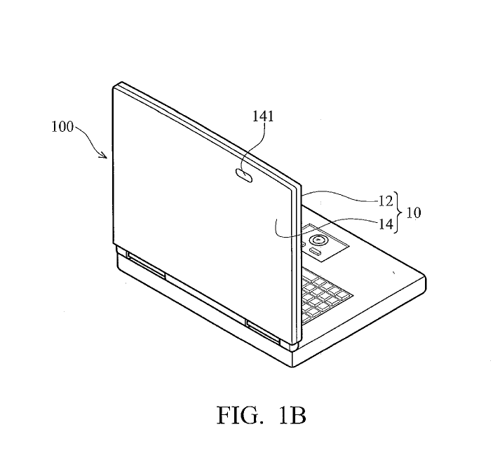

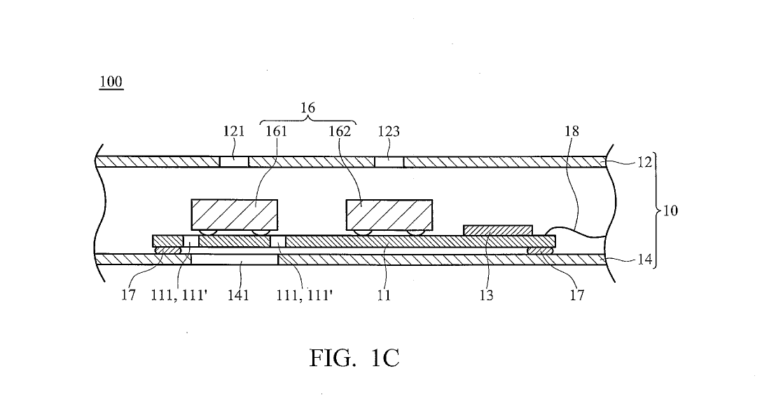

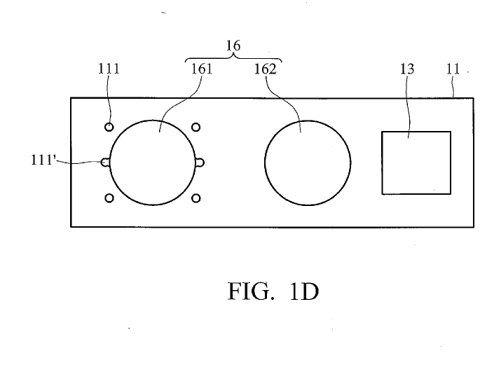

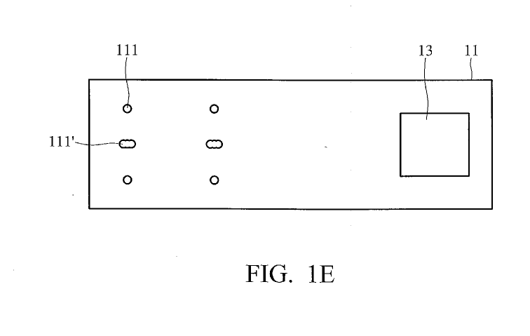

Referring to FIGS. 1A and 1B, in a first embodiment of the invention, a housing 10 of a portable computer 100 includes a front cover 12 and a rear cover 14. A first front acoustic opening 121 and a second front acoustic opening 123 are defined in the front cover 12. A rear acoustic opening 141 is defined in the rear cover 14.

Referring to FIG. 1C, in the housing 10 of the portable computer 100, a unidirectional microphone 161, an omnidirectional microphone 162, and an integrated circuit 13 are surface mounted on a circuit board 11, wherein the unidirectional microphone 161 and the omnidirectional microphone 162 constitute a microphone array 16. The unidirectional microphone 161 uses its top and bottom to receive external sound from the first front acoustic opening 121 and the rear acoustic opening 141 and generates analog electrical signals. The omnidirectional microphone 162 uses its top to receive external sound from the second front acoustic opening 123 and generates analog electrical signals. The integrated circuit 13 may be a digital signal processor (DSP) or an analog-to-digital converter (ADC), receiving the analog electrical signals from the unidirectional microphone 161 and omnidirectional microphone 162, converting the analog electrical signals to digital electrical signals, and sending out the digital electrical signals through conducting wires 18 to other circuitry (not shown).

The microphone array 16 is near the first front acoustic opening 121, the second front acoustic opening 123, and the rear acoustic opening 141 of the housing 10, thus, external sound reception capability is enhanced.

Referring to FIG. 1D, a plurality of through holes 111 and 111′ is defined in the circuit board 11 around the unidirectional microphone 161, allowing sound from the rear acoustic opening 141 to reach the unidirectional microphone 161. FIG. 1E depicts the circuit board 11 with no unidirectional microphone 161. From FIG. 1E, it is understood that the through holes 111′ extend lengthwise beneath the unidirectional microphone 161, thereby facilitating sound reception from the first front acoustic opening 121 as well as the rear acoustic opening 141 through the bottom of the unidirectional microphone 161.

The circuit board 11 can be fixed to the rear cover 14 by glue 17 as shown in FIG. 1C, or other means, for example, screws (not shown).

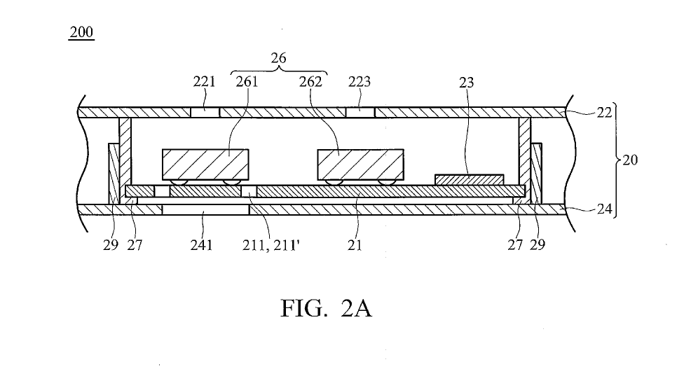

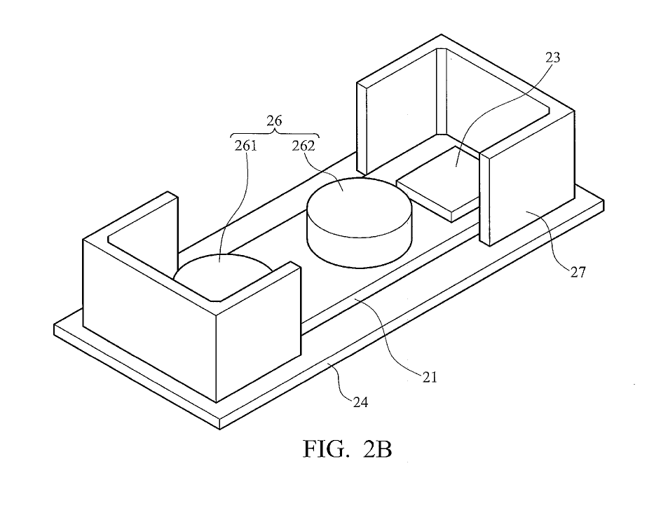

Referring to FIG. 2A, in a second embodiment of the invention, a housing 20 of an electronic device 200 includes a front cover 22 and a rear cover 24. The front cover 22 defines a first front acoustic opening 221 and a second front acoustic opening 223. The rear cover 24 defines a rear acoustic opening 241.

In the housing 20 of the electronic device 200, a unidirectional microphone 261, an omnidirectional microphone 262, and an integrated circuit 23 are surface mounted on a circuit board 21. The unidirectional microphone 261 and the omnidirectional microphone 262 constitute a microphone array 26. The unidirectional microphone 261 uses its top and bottom to receive external sound from the first front acoustic opening 221 and the rear acoustic opening 241 and generates analog electrical signals. The omnidirectional microphone 262 uses its top to receive external sound from the second front acoustic opening 223 and generates analog electrical signals. The integrated circuit 23 may be a digital signal processor (DSP) or an analog-to-digital converter (ADC), receiving analog electrical signals from unidirectional microphone 261 and omnidirectional microphone 262, converting the analog electrical signals to digital electrical signals, and sending the digital electrical signals to other circuitry (not shown).

A plurality of through holes 211 and 211′ is defined in the circuit board 21 around the unidirectional microphone 261, allowing sound from the rear acoustic opening 241 to reach the unidirectional microphone 261. Similar to the first embodiment, the through holes 211′ extend lengthwise beneath the unidirectional microphone 261, thereby facilitating reception of sound through the bottom of the unidirectional microphone 261 from the first front acoustic opening 221 as well as the rear acoustic opening 241.

A pair of flexible holders 27 extending from opposite directions secures the circuit board 21. The pair of flexible holders 27 is supported by backstays 29 in the horizontal direction and sandwiched between the front cover 22 and the rear cover 24 of the housing 20 in the vertical direction. The flexible holders 27 are made of, for example, rubber for protecting the microphone array 26 on the circuit board 21 from vibration. The flexible holders 27 may be U-shaped as shown in FIG. 2B.

In the second embodiment, the integrated circuit 23 and the microphone array 26 are disposed on the same side of the circuit board 21. The invention, however is not limited to this.

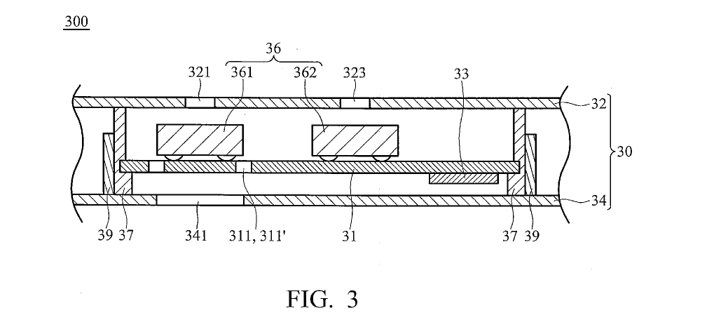

Referring to FIG. 3, in a third embodiment of the invention, a housing 30 of an electronic device 300 includes a front cover 32 and a rear cover 34. A first front acoustic opening 321 and a second front acoustic opening 323 are defined in the front cover 32. A rear acoustic opening 341 is defined in the rear cover 34.

In the housing 30 of the electronic device 300, a unidirectional microphone 361, an omnidirectional microphone 362, and an integrated circuit 33 are surface mounted on a circuit board 31. The unidirectional microphone 361 and the omnidirectional microphone 362 constitute a microphone array 36. The unidirectional microphone 361 uses its top and bottom to receive external sound from the first front acoustic opening 321 and the rear acoustic opening 341 and generates analog electrical signals. The omnidirectional microphone 362 uses its top to receive external sound from the second front acoustic opening 323 and generates analog electrical signals. The integrated circuit 33 may be a digital signal processor (DSP) or an analog-to-digital converter (ADC), receiving the analog electrical signals from the unidirectional microphone 361 and omnidirectional microphone 362, converting the analog electrical signals to digital electrical signals, and sending the digital electrical signals to other circuitry (not shown).

A plurality of through holes 311 and 311′ is defined in circuit board 31 around the unidirectional microphone 361, allowing sound from the rear acoustic opening 341 to reach the unidirectional microphone 361. Similar to the first and second embodiments, the through holes 311′ extend lengthwise beneath the unidirectional microphone 361, thereby facilitating reception of sound through the bottom of the unidirectional microphone 361 from the first front acoustic opening 321 as well as the rear acoustic opening 341.

A pair of flexible holders 37 extending from opposite directions secures the circuit board 31. The pair of flexible holders 37 is supported by backstays 39 in the horizontal direction and sandwiched between the front cover 32 and the rear cover 34 of the housing 30 in the vertical direction. The flexible holders 37 are made of, for example, rubber for protecting the microphone array 36 on the circuit board 31 from vibration. Note that in the third embodiment the integrated circuit 33 and the microphone array 36 are disposed on opposite sides of the circuit board 31.

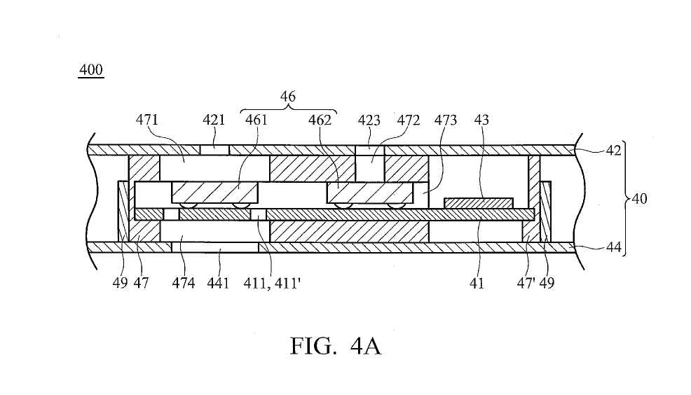

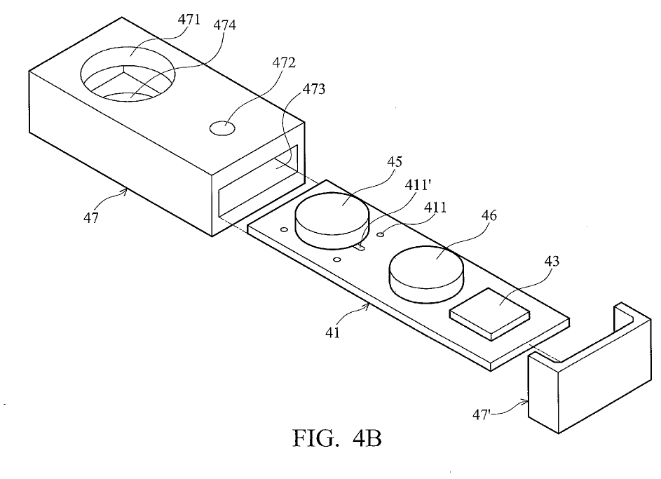

Referring to FIG. 4A, in a fourth embodiment of the invention, a housing 40 of an electronic device 400 includes a front cover 42 and a rear cover 44. A first front acoustic opening 421 and a second front acoustic opening 423 are defined in the front cover 42. A rear acoustic opening 441 is defined in the rear cover 44.

In the housing 40 of the electronic device 400, a unidirectional microphone 461, an omnidirectional microphone 462, and an integrated circuit 43 are surface mounted on a circuit board 41. The unidirectional microphone 461 and the omnidirectional microphone 462 constitute a microphone array 46. The unidirectional microphone 461 uses its top and bottom to receive external sound from the first front acoustic opening 421 and the rear acoustic opening 441 and generates analog electrical signals. The omnidirectional microphone 462 uses its top to receive external sound from the second front acoustic opening 423 and generates analog electrical signals. The integrated circuit 43 may be a digital signal processor (DSP) or an analog-to-digital converter (ADC), receiving the analog electrical signals from the unidirectional microphone 461 and omnidirectional microphone 462, converting the analog electrical signals to digital electrical signals, and sending the digital electrical signals to other circuitry (not shown).

A plurality of through holes 411 and 411′ is defined in the circuit board 41 around the unidirectional microphone 461, allowing sound from the rear acoustic opening 441 to reach the unidirectional microphone 461. Similar to the previously described embodiments, the through holes 411′ extend lengthwise beneath the unidirectional microphone 461, facilitating reception of sound from the first front acoustic opening 421 as well as the rear acoustic opening 441 through the bottom of unidirectional microphone 461.

A pair of flexible holders 47 extending from opposite directions secures the circuit board 41. The pair of flexible holders 47 is supported by backstays 49 in the horizontal direction and sandwiched between the front cover 42 and the rear cover 44 of the housing 40 in the vertical direction. The flexible holders 47 and 47′ are made of, for example, rubber for protecting the microphone array 46 on the circuit board 41 from vibration.

Referring to FIGS. 4A and 4B, the flexible holder 47′ is U-shaped. The flexible holder 47 has a first hole 473 on its side edge, a second hole 471 and a fourth hole 472 on its top, and a third hole 474 on its bottom, wherein the first hole 473 extends inward and connects to the second, third, and fourth holes 471, 474, and 472. The circuit board 41 is partially inserted into the flexible holder 47 through the first hole 473, wherein the unidirectional microphone 461 and the omnidirectional microphone 462 on the circuit board 41 are disposed in the flexible holder 47 but the integrated circuit 43 is not. The second hole 471 of the flexible holder 47 is connected to the first front acoustic opening 421 of the housing 40, allowing the unidirectional microphone 461 to receive external sound via the first front acoustic opening 421. The third hole 474 of the flexible holder 47 is connected to the rear acoustic opening 441 of the housing 40, allowing the unidirectional microphone 461 to simultaneously receive external sound via the rear acoustic opening 441. Similarly, the fourth hole 472 of the flexible holder 47 is connected to the second front acoustic opening 423 of the housing 40, allowing the omnidirectional microphone 462 to receive external sound via the second front acoustic opening 423.

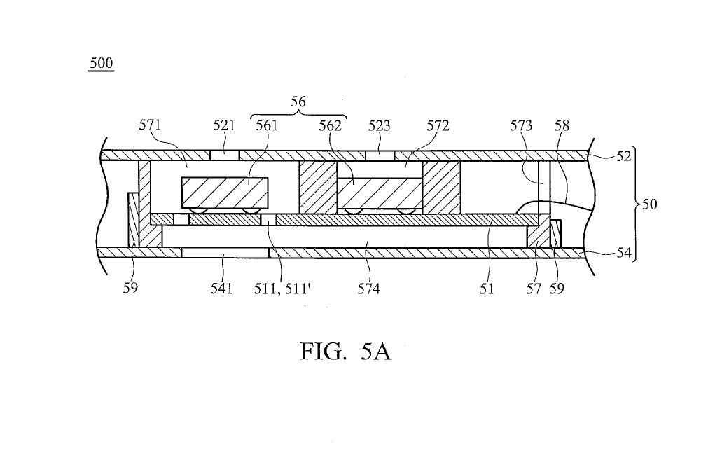

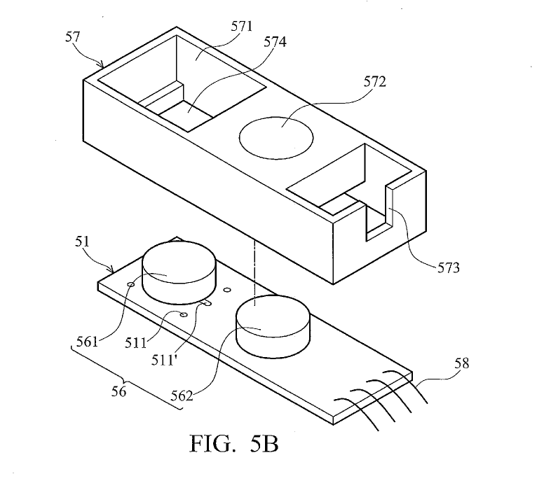

Referring to FIG. 5A, in a fifth embodiment of the invention, a housing 50 of an electronic device 500 includes a front cover 52 and a rear cover 54. A first front acoustic opening 521 and a second front acoustic opening 523 are defined in the front cover 52. A rear acoustic opening 541 is defined in the rear cover 54.

In the housing 50 of the electronic device 500, a microphone array 56 includes a unidirectional microphone 561 and an omnidirectional microphone 562 surface mounted on a circuit board 51 for receiving external sound. In detail, the unidirectional microphone 561 uses its top and bottom to receive external sound from the first front acoustic opening 521 and the rear acoustic opening 541 and sends out electrical signals through conducting wires 58. Similarly, the omnidirectional microphone 562 uses its top to receive external sound from the second front acoustic opening 523 and sends out electrical signals through the conducting wires 58.

A plurality of through holes 511 and 511′ is defined in the circuit board 51 around the unidirectional microphone 561, allowing sound from the rear acoustic opening 541 to reach the unidirectional microphone 561. Similar to the previously described embodiments, the through holes 511′ extend lengthwise beneath the unidirectional microphone 561, facilitating sound reception from the first front acoustic opening 521 as well as the rear acoustic opening 541 through the bottom of the unidirectional microphone 561.

A pair of flexible holders 57 extending from opposite directions secures the circuit board 51. The pair of flexible holders 57 is supported by backstays 59 in the horizontal direction and sandwiched between the front cover 52 and the rear cover 54 of the housing 50 in the vertical direction. The flexible holder 57 is made of, for example, rubber for protecting the microphone array 56 on the circuit board 51 from vibration.

Referring to FIGS. 5A and 5B, the flexible holder 57 is hollow and has a top opening 571, a top hole 572, a concave side cut 573, and a bottom opening 574. The circuit board 51 comprising microphone array 56 is disposed in the flexible holder 57 with the conducting wires 58 passing through the concave side cut 573. The top opening 571 of the flexible holder 57 is connected to the first front acoustic opening 521 of the housing 50, allowing the unidirectional microphone 561 to receive external sound via the first front acoustic opening 521. The bottom opening 574 of the flexible holder 57 is connected to the rear acoustic opening 541 of the housing 50, allowing the unidirectional microphone 561 to simultaneously receive external sound via the rear acoustic opening 541. The top hole 572 of the flexible holder 57 is connected to the second front acoustic opening 523 of the housing 50, allowing the omnidirectional microphone 562 to receive external sound via the second front acoustic opening 523.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a housing defining a plurality of acoustic openings;
a circuit board disposed in the housing; and
a microphone array disposed on the circuit board, receiving external sound via the acoustic openings.

2. The electronic device as claimed in claim 1, further comprising glue fixing the circuit board to the housing.

3. The electronic device as claimed in claim 1, further comprising a screw fixing the circuit board to the housing.

4. The electronic device as claimed in claim 1, further comprising an integrated circuit disposed on the circuit board.

5. The electronic device as claimed in claim 4, wherein the integrated circuit comprises a digital signal processor.

6. The electronic device as claimed in claim 4, wherein the integrated circuit comprises an analog-to-digital converter.

7. The electronic device as claimed in claim 4, wherein the integrated circuit and the microphone array are disposed on the same side of the circuit board.

8. The electronic device as claimed in claim 4, wherein the integrated circuit and the microphone array are disposed on opposite sides of the circuit board.

9. The electronic device as claimed in claim 1, wherein the microphone array comprises a unidirectional microphone, and the circuit board defines a plurality of through holes around the unidirectional microphone.

10. The electronic device as claimed in claim 9, wherein at least one through hole extends lengthwise beneath the unidirectional microphone.

11. The electronic device as claimed in claim 1, further comprising a flexible holder holding the circuit board, wherein the housing comprises a front cover and a rear cover, with the flexible holder sandwiched therebetween.

12. The electronic device as claimed in claim 11, wherein the flexible holder is substantially U-shaped.

13. The electronic device as claimed in claim 11, wherein the acoustic openings comprise a first front acoustic opening, a second front acoustic opening, and a rear acoustic opening, and the microphone array comprises a unidirectional microphone receiving external sound via the first front acoustic opening and the rear acoustic opening, and an omnidirectional microphone receiving the external sound via the second front acoustic opening.

14. The electronic device as claimed in claim 13, wherein the flexible holder comprises a first hole with the microphone array and a part of the circuit board inserted therein.

15. The electronic device as claimed in claim 14, wherein the flexible holder further comprises a second hole connecting the first front acoustic opening of the housing and the first hole, a third hole connecting the rear acoustic opening of the housing and the first hole, and a fourth hole connecting the second front acoustic opening of the housing and the first hole.

16. The electronic device as claimed in claim 13, wherein the flexible holder is hollow with the microphone array and the circuit board disposed therein.

17. The electronic device as claimed in claim 16, wherein the flexible holder comprises a top opening connected to the first front acoustic opening of the housing, a top hole connected to the second front acoustic opening of the housing, and a bottom opening connected to the rear acoustic opening of the housing.

18. The electronic device as claimed in claim 11, further comprising a conducting wire connected to the circuit board, wherein the flexible holder comprises a concave cut with the conducting wire passing therethrough.

19. The electronic device as claimed in claim 11, wherein the flexible holder comprises rubber.
